(19) United States
(12) Patent Application Publication
(10) Pub. No.: US 2013/0282464 A1
(43) Pub. Date: Oct. 24, 2013

(54) SYSTEMS AND METHODS FOR PROVIDING LOYALTY PROGRAMS VIA A DEBIT CARD

(71) Applicant: Michael Bradley, Toronto (CA)

(72) Inventor: Michael Bradley, Toronto (CA)

(21) Appl. No.: 13/450,989

(22) Filed: Apr. 19, 2012

(51) Int. Cl. G06Q 30/02

(52) U.S. Cl. 705/14.27

(57) ABSTRACT

A method and system are provided for linking loyalty programs for merchants and debit card customers. This involves storing, in a database memory, loyalty program identifiers, debit card customer identifiers, for each debit card customer and each loyalty program in which that debit card customer is registered, a loyalty program customer identifier and merchant identifiers; receiving transaction information, which includes debit card holder information, a merchant identifier and purchase information, from a merchant; locating a debit card customer identifier corresponding to the debit card holder identifier; determining the loyalty program identifier for the merchant; and determining if the debit card customer identifier is stored in the database memory in linked relation with a loyalty program customer identifier stored in linked relation to the loyalty program identifier and, if so, determining a loyalty program manager, and transmitting the loyalty program customer identifier and the purchase information to the loyalty program manager.

### FIELD

The described embodiments relate to systems and methods for providing loyalty programs via a debit card.

### INTRODUCTION

Consumers are frequently offered memberships in loyalty programs sponsored by different retailers and merchants. Loyalty programs can be provided by retailer(s) as to gain a competitive advantage over, or market share from, their competitors. Retailers can provide incentives, such as points, store credits, coupons and/or promotional offers, to loyalty reward program members to encourage members to return as customers. Since membership can be at no cost to consumers, consumers often become members of many different loyalty programs. Retailers, on the other hand, continue to be concerned with minimizing the cost of offering these loyalty programs.

There, thus, is a need for retailers to lower the costs of offering loyalty programs and for consumers to more easily earn loyalty rewards.

### SUMMARY

In accordance with an aspect of an embodiment of the invention, there is provided a method of linking a plurality of loyalty programs for a plurality of merchants and a plurality of debit card customers. The method comprises: a) storing, in a database memory, i) a plurality of loyalty program identifiers identifying the plurality of loyalty programs, wherein each loyalty program identifier uniquely identifies a loyalty program in the plurality of loyalty programs; ii) a plurality of debit card customer identifiers identifying the plurality of debit card customers, wherein each debit card customer identifier uniquely identifies a debit card customer in the plurality of debit card customers; iii) for each debit card customer and for each loyalty program in which that debit card customer is registered, a loyalty program customer identifier identifying that debit card customer for that loyalty program; and iv) a plurality of merchant identifiers identifying the plurality of merchants; wherein, each loyalty program identifier in the plurality of loyalty program identifiers is stored in the database memory in linked relation to at least one merchant identifier in the plurality of merchant identifiers, each debit card customer identifier in the plurality of debit card customer identifiers is stored in the database memory in linked relation to at least one loyalty program customer identifier in the plurality of loyalty program customer identifiers, and each loyalty program customer identifier is stored in the database memory in linked relation to an associated loyalty program identifier; b) at a transaction capture module, receiving transaction information from a merchant in the plurality of merchants, wherein the transaction information comprises debit card holder information derived from a debit card held by a debit card holder, a merchant identifier identifying the merchant and purchase information regarding a purchase from the merchant by the debit card holder, and wherein the debit card holder information comprises a debit card holder identifier; and c) operating a mapping and switching processor, linked to the transaction capture module and to the database memory for electronic communication therewith, to i) locate, in the database memory, a debit card customer identifier corresponding to the debit card holder identifier; ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier; and iii) determine if the debit card customer identifier is stored in the database memory in linked relation with a loyalty program customer identifier that is stored in the database memory in linked relation to the loyalty program identifier for the merchant and, if so, determining a loyalty program manager based on the determined loyalty program identifier, and transmitting the loyalty program customer identifier and the purchase information to the loyalty program manager; otherwise, not transmitting the purchase information to the loyalty program manager without approval from the debit card customer corresponding to the debit card customer identifier.

In accordance with an embodiment of the invention, there is provided a system for linking a plurality of loyalty programs for a plurality of merchants and a plurality of debit card customers. The system comprising: a database memory, for storing i) a plurality of loyalty program identifiers identifying the plurality of loyalty programs, wherein each loyalty program identifier uniquely identifies a loyalty program in the plurality of loyalty programs; ii) a plurality of debit card customer identifiers identifying the plurality of debit card customers, wherein each debit card customer identifier uniquely identifies a debit card customer in the plurality of debit card customers; iii) for each debit card customer and for each loyalty program in which that debit card customer is registered, a loyalty program customer identifier identifying that debit card customer for that loyalty program; and iv) a plurality of merchant identifiers identifying the plurality of merchants; wherein, each loyalty program identifier in the plurality of loyalty program identifiers is stored in the database memory in linked relation to at least one merchant identifier in the plurality of merchant identifiers, each debit card customer identifier in the plurality of debit card customer identifiers is stored in the database memory in linked relation to at least one loyalty program customer identifier in the plurality of loyalty program customer identifiers, and each loyalty program customer identifier is stored in the database memory in linked relation to an associated loyalty program identifier; a transaction capture module configured to receive transaction information from a merchant in the plurality of merchants, wherein the transaction information comprises debit card holder information derived from a debit card held by a debit card holder, a merchant identifier identifying the merchant and purchase information regarding a purchase from the merchant by the debit card holder, and wherein the debit card holder information comprises a debit card holder identifier; a mapping and switching processor, linked to the transaction capture module and to the database memory for electronic communication therewith, the mapping and switching processor being configured to i) locate, in the database memory, a debit card customer identifier corresponding to the debit card holder identifier; ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier; and iii) determine if the debit card customer identifier is stored in the database memory in linked relation with a loyalty program customer identifier that is stored in the database memory in linked relation to the loyalty program identifier for the merchant and, if so, determine a loyalty program manager based on the determined loyalty program identifier, and transmitting the loyalty program customer identifier and the purchase information to the loyalty program manager.

### DRAWINGS

A preferred embodiment of the present invention will now be described in detail with reference to the drawings, in which:

FIG. 1 is a block diagram of a debit card loyalty network for providing loyalty programs via a debit card, in accordance with an embodiment of the present disclosure;

FIG. 2 is a block diagram of a system for providing loyalty programs via a debit card, in accordance with an embodiment of the present disclosure;

FIG. 3 is a flowchart diagram illustrating the steps of providing loyalty programs via a debit card, in accordance with an embodiment of the present disclosure;

FIG. 4 is a screenshot of an example online banking user interface configured with the customer interface module, in accordance with an embodiment of the present disclosure;

FIG. 5 is a screenshot of an interface for linking a loyalty program account to the debit card account, in accordance with an embodiment of the present disclosure; and

FIG. 6 is a screenshot of an interface for accessing loyalty program accounts linked to the debit card account, in accordance with an embodiment of the present disclosure.

### DESCRIPTION OF VARIOUS EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein. Where considered appropriate, for simplicity and clarity of illustration, reference numerals may be repeated among the figures to indicate corresponding or analogous elements or steps.

The embodiments of the systems and methods described herein may be implemented in hardware or software, or a combination of both. However, preferably, these embodiments are implemented in computer programs executing on programmable computers each comprising at least one module component which comprises at least one processor (e.g., a microprocessor) and/or memory or storage elements, a data storage system (including volatile and non-volatile memory and/or storage elements), at least one input device, and at least one output device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

The various embodiments described herein generally relate to methods (and associated systems configured to implement the methods) for providing loyalty programs via a debit card in a debit card loyalty system. The method includes linking, or associating, loyalty programs to a debit card account of a debit card user or holder (herein referred to as a debit card holder). Each loyalty program can be associated with one or more merchants and also corresponds to a loyalty program operator or manager. Merchants can include retailers and any other business entities. Each debit card holder who is a participant of, or registered with, a loyalty program can also be associated with a loyalty customer account for that loyalty program. When the debit card holder registers with the debit card loyalty system, that debit card holder can become a debit card customer with a debit card customer identifier. When that debit card, after it is associated with a loyalty program account for a loyalty program, is used in a payment transaction with a merchant associated with that loyalty program, information identifying the loyalty program account and information associated with the payment transaction can be automatically transmitted to the loyalty program manager of the loyalty program.

Debit cards, or bank cards, can be used to access bank accounts at financial institutions and can also be used to make purchases in payment transactions. By enabling loyalty programs to be associated with debit cards, consumers are more likely to use debit cards for making purchases. For merchants, increased use of debit cards in payment transactions offers transactional advantages since receiving payment via debit cards is typically more convenient than with cash and debit cards are associated with lower transaction costs than credit cards. For consumers, the association of loyalty programs with debit cards offers convenience since consumers no longer need to carry physical loyalty program identifications (e.g., plastic cards) in order to indicate their participation, or membership, in the loyalty programs. Instead, by linking a consumer's loyalty program account to the debit card account, that consumer's membership in the loyalty program can be automatically determined when that consumer uses the debit card account at the retailer associated with that loyalty program. Further, as the rewards offered by a loyalty program associated with a merchant are more likely to be redeemed at that merchant (as compared to, say, Air Miles®), the merchant can afford to be more generous with the rewards offered both because the merchant's transaction cost can be lower (due to using a debit card instead of a credit card), and because the costs of the rewards offered by the merchant can be based on the cost of the goods or services offered by the merchant instead of being based on the price the customer would typically pay for those goods or services.

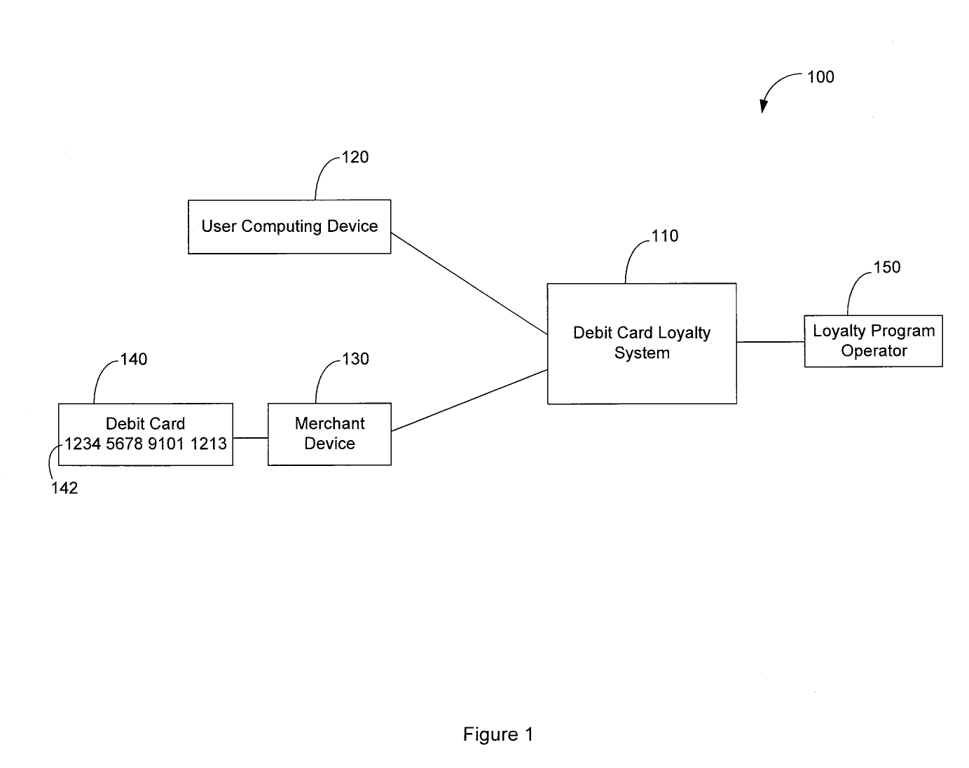

Reference is first made to FIG. 1, which shows a block diagram illustrating a debit card loyalty network 100 for providing loyalty programs via a debit card.

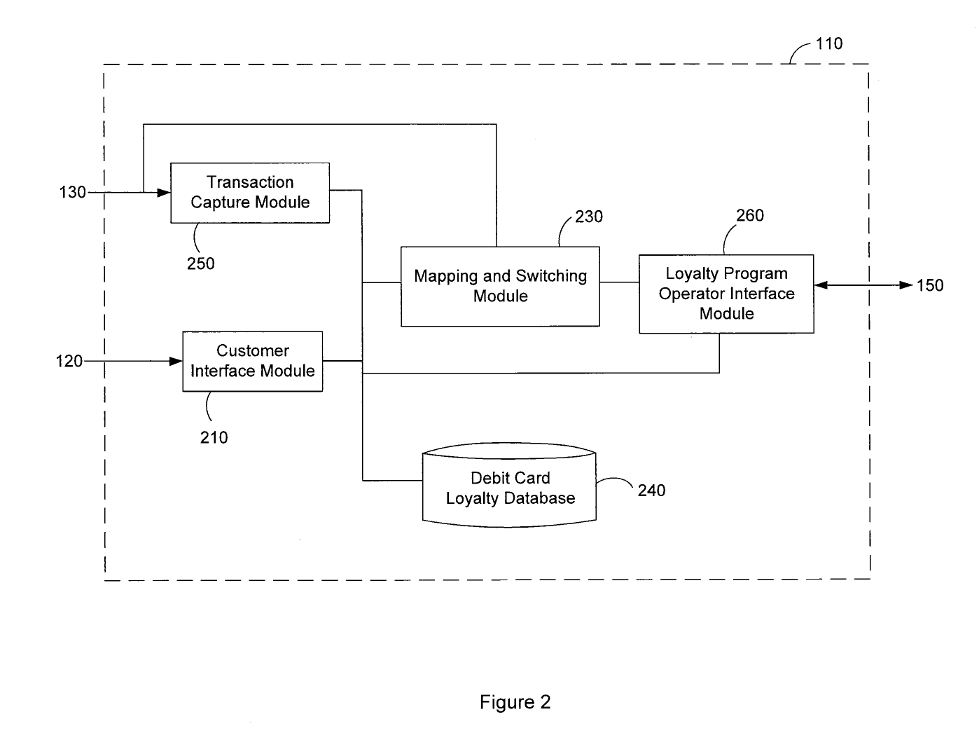

The debit card loyalty network 100 includes a debit card loyalty system 110. The debit card loyalty system 110 is described, below, with reference to FIG. 2. The debit card loyalty network 100 also includes a user computing device 120, a merchant device 130 and a loyalty program operator 150. Each of the user computing device 120, the merchant device 130 and the loyalty program operator 150 are in communication with the debit card loyalty system 110. It will be understood that one or more of each of the user computing devices 120, the merchant device 130 and the loyalty program operator 150 can, in some embodiments, be part of the debit card loyalty network 100.

The user computing device 120 may be any device used by any debit card users (e.g., a debit card holder and/or a debit card customer) for interacting with the debit card loyalty system 110. It may, for example, be a personal computer or mobile device equipped with an Internet or network connection that can be used by the debit card user for other purposes, such as online banking. Alternatively, the user computing device 120 may be a kiosk device or station, an automated teller machine (ATM), and any other machine operable for the debit card user to directly or indirectly interact with the debit card loyalty system 110. For example, the debit card user can indirectly interact with the debit card loyalty system 110 through a teller operating his or her computing device at a bank branch. It will be understood that in the embodiments where one or more user computing devices 120 are used as part of the debit card loyalty network 100, the user computing devices 120 may be the same or different types of computing devices.

The merchant device 130 may be any payment transaction device that can retrieve and process account information stored on a payment card, such as a debit card 140. As described above, debit cards 140 may also be referred to as bank cards because they can be used to access bank accounts at financial institutions. The debit cards 140 can also be used to make purchases in payment transactions. Generally, debit cards 140 are identified by a unique identifier 142, such as a debit card number, or any other identifying reference value that identifies the debit card 140. The unique identifier 142 may be referred to herein as a debit card account identifier or a debit card holder identifier.

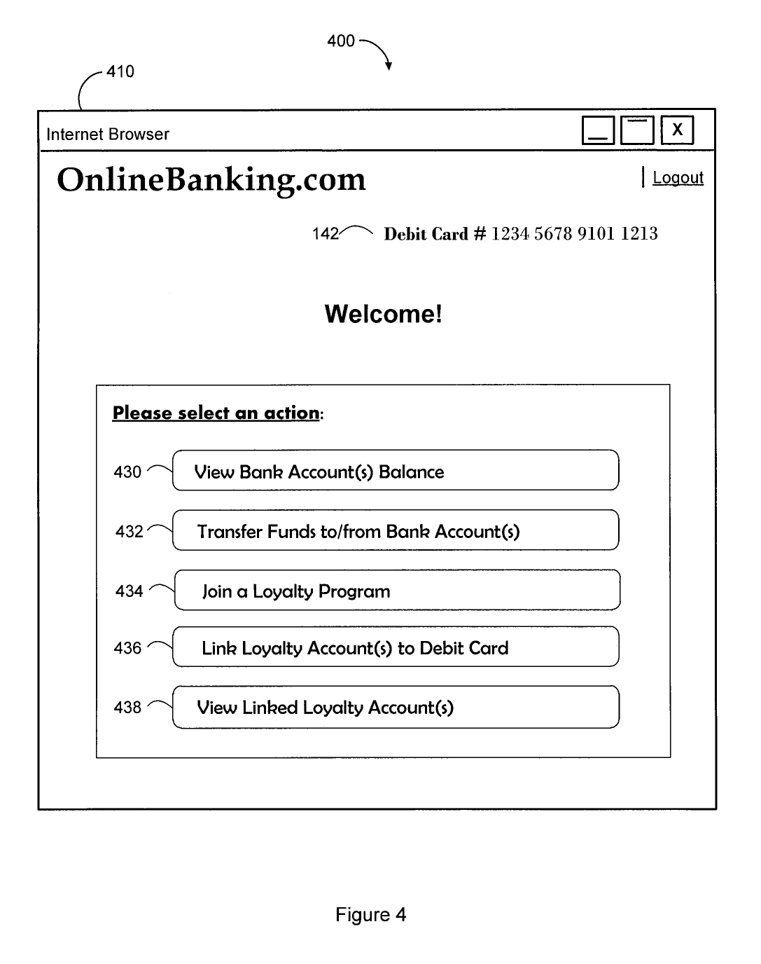

As briefly described above, in order to link a loyalty program account to a debit card account, the debit card holder needs to register or become associated with the debit card loyalty system 110. When the debit card holder becomes associated with the debit card loyalty system 110, that debit card holder becomes a debit card customer of the debit card loyalty system 110 and becomes associated with a debit card customer identifier stored in the debit card loyalty database 240. The debit card holder can become associated with the debit card loyalty system 110 by initializing registration with the debit card loyalty system 110 (as will be described below with reference to FIG. 4) and/or when personal information associated with that debit card holder is provided to the debit card loyalty system 110 by a deposit account-holding entity, such as a financial institution for example.

As briefly described above, a loyalty program may be associated with one or more merchants. Each loyalty program is managed and/or implemented by a corresponding loyalty program operator 150. The merchant can be the loyalty program operator 150. The loyalty program operator 150 receives information or data associated with a payment transaction based on which the loyalty program operator can determine if a reward has been earned. The data received by the loyalty program operator 150 can include an identifier identifying the debit card customer to the loyalty program (referred to herein as a loyalty program customer identifier) and purchase information regarding the purchase made by the debit card customer from the merchant. If a reward has been earned, the loyalty program operator 150 may further compute or determine the value of the reward.

The debit card may also be used to redeem a reward or to exercise a promotion or offer provided by the loyalty program. For example, the debit card customer with a debit card account linked with a loyalty program account for the merchant's loyalty program can choose to redeem a reward associated with the loyalty program. The reward could be, for example, a 10% discount off the payment transaction in exchange for 500 points from the loyalty program account.

There are various methods in which the debit card can be used to redeem a reward. In one example, the request can be submitted at a point of sale. Using the mapping and switching module 230, the debit card can be used to identify the debit card customer and to provide corresponding loyalty program customer information (e.g., the loyalty program customer identifier, loyalty program account balance for that loyalty program customer, etc.) for that debit card customer to the merchant device 130. The merchant device 130 can then enable the debit card customer to select to redeem and apply a reward before proceeding with the payment transaction. Alternatively, the reward could be redeemed as part of the payment transaction, that is, a request to redeem a reward and the transaction information are submitted together. In another example, the reward can be submitted prior to a payment transaction, such as through an interface provided by the customer interface module 210 on a mobile device while in line to pay for a purchase or at home prior to visiting the merchant, and in response, a voucher or redemption code is provided to the debit card customer to redeem the reward at the merchant.

Referring now to FIG. 2, an example embodiment of the debit card loyalty system 110 is shown in a block diagram.

The debit card loyalty system 110 may include a customer interface module 210, a mapping and switching module 230, a debit card loyalty database 240, a transaction capture module 250, and a loyalty program operator interface module 260. The mapping and switching module 230 may include a processor (e.g., a mapping and switching processor) and/or a memory or storage element. As illustrated in FIG. 2, each of the components in the debit card loyalty system 110 may be in communication with any of the other components.

The debit card loyalty database 240 is an example data storage system and may include one or more databases. For example, the debit card loyalty database 240 can include a database for storing information associated with debit card customers and a database for storing information associated with loyalty programs. Alternatively, information associated with both the debit card customers and loyalty programs can be stored in one database.

To facilitate the linking of a loyalty program account with a debit card number, the debit card loyalty system 110 can store information related to the debit card number and the loyalty program in the debit card loyalty database 240. Other information may be stored in the debit card loyalty database 240 to facilitate other services provided by the debit card loyalty system 110.

Information regarding each loyalty program can be provided from the loyalty program operators 150 and the debit card users via the user computing devices 120. The loyalty program operators 150 can communicate with the debit card loyalty system 110 through the loyalty program operator interface module 260, whereas the user computing devices 120 can communicate with the debit card loyalty system 110 through the customer interface module 210.

Each loyalty program operator 150 can provide information related to their corresponding loyalty program (referred to herein as program description information) to the loyalty program operator interface module 260 to add or register loyalty programs into the debit card loyalty system 110. The loyalty program operator interface module 260 may be configured to provide the program description information directly to the debit card loyalty database 240 for storage and/or to the mapping and switching module 230 for processing. If the mapping and switching module 230 receives the program description information, the mapping and switching module 230 can process the program description information to generate processed program description information and can then store the processed program description information in the debit card loyalty database 240.

A loyalty program can be registered in the debit card loyalty system 110 after the corresponding program description information is stored in the debit card loyalty database 240. For each registered loyalty program, the corresponding program description information that is stored in the debit card loyalty database 240 may include an identifier for a registered loyalty program (referred to herein as a registered loyalty program identifier), a description of the registered loyalty program, identifiers for one or more merchants associated with the registered loyalty program (referred to herein as registered merchant identifiers), information required from a new loyalty program customer to become a member of the loyalty program, a validation protocol for validating a loyalty program account identifier associated with a loyalty program account of the registered loyalty program, information indicating a format preference for how the purchase information is to be received by the loyalty program operator of the registered loyalty program, and other information relevant to the registered loyalty program. One or more loyalty programs may prefer to receive the purchase information in one format, while one or more other loyalty programs may prefer to receive the purchase information in another format. The format preference may define, for example, the order and format in which information, such as the customer identifier, the date and time of the purchase, the identity of the merchant at which the purchase is made, the type of loyalty program membership of the customer, as well as other information, can be transmitted and/or received.

As described above, the user computing devices 120 can also provide information related to the loyalty program to the customer interface module 210, when, for example, a debit card holder is already a member of a loyalty program, and wants to be able to use their debit card to identify themselves to that loyalty program. Additionally, the user computing devices 120 can provide the debit card account information to the customer interface module 210.

The customer interface module 210 can act as a customer user interface for the debit card loyalty system 110 by facilitating communication with the user computing device 120. The customer interface module 210 can receive information associated with the loyalty program and debit card account information from the user computing device 120. The loyalty program information may include an identifier for the loyalty program (herein referred to as a loyalty program identifier) and/or an identifier for a loyalty account (herein referred to as a loyalty program account identifier or a loyalty program customer identifier) for the loyalty program. The debit card account information may include the debit card holder identifier 142. Like the loyalty program operator interface module 260, the customer interface module 210 may provide the loyalty program information and debit card account information received from the user computing device 120 to the mapping and switching module 230, or may instead directly store the loyalty program information and debit card account information in the debit card loyalty database 240.

In some embodiments, the loyalty programs available to be associated with the debit card account may be limited to the loyalty programs registered with the debit card loyalty system 110. In one example configuration, the customer interface module 210 can provide a list of the registered loyalty programs stored in the debit card loyalty database 240 and the debit card customer can only select a loyalty program from that list to be associated with the debit card account. For example, the customer interface module 210 can include a drop down list control consisting of loyalty programs registered in the debit card loyalty system 110, and a debit card customer who wants to associate a loyalty program to his debit card account can only select a loyalty program from the drop down list control. The loyalty program identifiers received from the corresponding user computing device 120 can, thus, be limited to the loyalty programs provided in the drop down list control.

In some embodiments, the customer interface module 210 can be configured through a banking channel, such as an online banking website or an ATM machine, associated with a deposit account-holding entity, such as a financial institution. The financial institution can choose to provide a subset of loyalty programs registered with the debit card loyalty system 110 with which its customers can associate their debit card accounts. This implementation enables financial institutions to establish exclusive relationships with selected loyalty programs that can offer business advantages for both the financial institution and the loyalty program. As well, these exclusive relationships can add substantial value to the financial institution's banking services and may, as a result, attract new customers to its banking services.

Before providing the loyalty program information and debit card account information to the mapping and switching module 230 and/or the debit card loyalty database 240, the customer interface module 210 may process the information received from the customer interface module 210. For the purpose of enhancing the security of the debit card accounts, the debit card customer identifier can be a secure token (referred to herein as a secure debit card customer token) derived from information corresponding to the debit card held by the debit card customer. The secure token can be generated using any known cryptographic and/or hashing algorithms that hides or locks the identification information but can nevertheless be decrypted or unlocked with a security protocol to reveal the hidden identification information. Although the secure debit card customer token is different from the debit card number of the debit card held by the debit card customer, as long as the correct unlocking security protocol is known, the secure debit card customer token can be decrypted to reveal the debit card information related to the debit card held by the debit card customer. In some embodiments, decryption of secure tokens can occur in a security module in the debit card loyalty system 110.

In some embodiments, the customer interface module 210 may operate to display the account balance of linked loyalty program accounts and/or receive requests related to the linked loyalty program accounts. For example, the customer interface module 210 may operate to display a most recent reward balance for all loyalty program accounts linked to a debit card account, and may further operate to provide options for redeeming rewards from any of the associated loyalty program accounts. In another example, the customer interface module 210 may operate to provide options for removing one or more associated loyalty program accounts from being linked to the debit card account.

In some embodiments, the customer interface module 210 may operate to provide options to enable multiple loyalty program account identifiers corresponding to the same loyalty program to be associated to one debit card account. Optionally, the customer interface module 210 may further operate to provide options for selecting one of the multiple loyalty program account identifiers as a preferred loyalty program account identifier. Some debit card customers may find it advantageous to have multiple loyalty program account identifiers corresponding to one loyalty program associated with one debit card account. For example, a supermarket's loyalty program may offer a promotion that benefits each loyalty account only once. In the case of a couple, for example, one spouse, such as the wife, may be primarily responsible for shopping at that supermarket. It may therefore be beneficial for the wife's debit card account to be associated with both her and her husband's loyalty program accounts in that supermarket's loyalty program. That way, she can benefit from the promotion twice, that is, once with her loyalty program account and again with her husband's loyalty program account when shopping at that supermarket.

Also, the customer interface module 210 may operate to display promotions and/or offers corresponding to loyalty programs. In some embodiments, the promotions and/or offers may vary in accordance with transaction and/or profile information associated with the loyalty program accounts and/or debit card accounts.

The customer interface module 210 may also operate to create a customer profile for each debit card customer. The customer profile can include personal information for that customer (e.g., name, birthdate, contact information, etc.), personal interests, transaction preferences (e.g., frequently visited shops and/or merchants, historical purchases, purchase habits, etc.), and other relevant customer information. This customer profile can be stored in the debit card loyalty database 240 or a database accessible by the customer interface module 210. Optionally, the customer interface module 210 may also be operable by the customer to consent to providing some or all of the personal information included in his or her customer profile to one or more of the loyalty programs to which that customer is linked. If such consent is provided, then this personal information can be provided to one or more of the loyalty programs.

In some embodiments, as will be described with reference to FIGS. 4 to 6, the customer interface module 210 may be provided through an Internet or online banking user interface. For example, the customer interface module 210 may be implemented on an existing internet banking web application.

The customer interface module 210 and the loyalty program operator interface module 260 may be configured to offer additional services associated with the debit card loyalty system 110. The customer interface module 210 and the loyalty program operator interface module 260 may be configured to operate individually and/or together to provide these additional services. Optionally, the mapping and switching module 230 may be configured to provide these additional services.

For example, in some embodiments, before the customer interface module 210 transmits the loyalty program information and the debit card account information received from the user computing devices 120, the customer interface module 210 may validate the loyalty program account identifier using validation protocols provided, via the loyalty program operator interface module 260, by the loyalty program operator 150 for the corresponding loyalty program. In this way, the customer interface module 210 can ensure that only valid loyalty program account identifiers are transmitted and/or stored in the debit card loyalty system 110.

In another example, the customer interface module 210 may receive, from user computing devices 120, requests and/or registration information for registering and/or enrolling into loyalty programs.

When the customer interface module 210 receives a request from a user computing device 120 to register a debit card user to a loyalty program, the customer interface module 210 may, in some embodiments, create a loyalty program account for the new loyalty program member and provide or assign a new loyalty program account identifier to that loyalty program account. Alternatively, the customer interface module 210 may forward the request to the loyalty program operator 150 for the loyalty program, via the loyalty program operator interface module 260, for processing and/or approval. The loyalty program operator 150 can then provide or assign a new loyalty program account identifier for the requesting debit card user.

The registration information required to create a loyalty program account for a loyalty program may be predetermined by the loyalty program operator 150 when that loyalty program operator 150 registered the loyalty program in the debit card loyalty system 110. This makes it easier for new customers to sign up with that loyalty program. The registration information can also be retrieved directly from the customer profile created by the customer interface module 210 for that debit card customer, or can be provided from the customer via the customer interface module 210. Alternatively, the registration information can be supplied by both sources, that is, retrieving information from the customer profile created by the customer interface module 210 and from the customer via the customer interface module 210.

Optionally, the customer interface module 210 may also operate to display advertisements and/or marketing information to the debit card customer regarding loyalty programs that the debit card customer can sign up for. Further, optionally, the selection of which loyalty programs to be displayed to the debit card customer can be based on what loyalty programs the debit card customer is currently signed up for (that is, the loyalty programs being advertised to the debit card customer can be selected so that loyalty programs in which the debit card customer is already a member are excluded),

In some embodiments, the advertisements and/or marketing information can include promotions and/or offers associated with the loyalty programs for which the debit card customer is already a member. For example, one of the debit card customer's loyalty programs can advertise that its loyalty program customers are eligible to earn double reward points for any purchases made at any associated merchants each Monday.

After the request to register and/or registration information is received by a loyalty program operator 150, the mapping and switching module 230 may need an approval notification or confirmation from the loyalty program operator 150 before the requesting debit card customer is a registered member of the loyalty program.

As described above, to associate a loyalty program account to a debit card account, the customer interface module 210 may provide the received loyalty program information and the debit card account information to the mapping and switching module 230, or may instead store the received information directly into the debit card loyalty database 240. In the case that the debit card loyalty database 240 receives the loyalty program information and debit card account information from the customer interface module 210, the customer interface module 210 can query the debit card loyalty database 240 to determine if an existing entry corresponds to the received debit card holder identifier 142. If, instead, the debit card loyalty database 240 receives the loyalty program information and debit card account information from the mapping and switching module 230 instead, it is the mapping and switching module 230 that may operate to query the debit card loyalty database 240.

If no entry in the debit card loyalty database 240 corresponds to the debit card holder identifier 142, a debit card customer identifier corresponding to the debit card holder identifier 142 can be stored in a new entry in the debit card loyalty database 240 along with the received loyalty program information. As described above, the loyalty program information received from the user computing device 120 can include the loyalty program identifier and the loyalty program account identifier associated with the loyalty program identifier. The received loyalty program account identifier can then be stored in linked relation in the debit card loyalty database 240 with the debit card customer identifier and the loyalty program identifier.

If a debit card customer identifier in an entry in the debit card loyalty database 240 corresponds to the debit card holder identifier 142, the customer interface module 210 can again query the debit card loyalty database 240 to determine if that debit card customer identifier is linked with a loyalty program account identifier associated with the loyalty program identified by the received loyalty program identifier.

If the debit card customer identifier is not linked with a loyalty program account identifier associated with that loyalty program, the loyalty program account identifier can then be stored in the debit card loyalty database 240 in linked relation with the received loyalty program identifier and the debit card customer identifier.

On the other hand, if the debit card customer identifier is linked with a loyalty program account associated with the received loyalty program identifier, that debit card account is already linked with the loyalty program and the customer interface module 210 may display a message to the user computing device 120 to inform the debit card customer accordingly.

After a loyalty program account of a loyalty program is associated with a debit card account, when that debit card account is used in payment transactions at a merchant associated with the loyalty program, the loyalty program account can automatically earn rewards for that payment transaction.

During the payment transaction, the mapping and switching module 230 may receive transaction data directly from the merchant device 130 and/or from the transaction capture module 250. In some embodiments, the transaction information can be received from the merchant device 130 via a deposit account-holding entity (e.g., a financial institution), a debit card network which may include one or more issuers or issuing banks of debit cards, and a processing agent for the merchant that processes payment transactions on behalf of that merchant.

The transaction capture module 250 can operate to retrieve, from the merchant device 130, the transaction data associated with the payment transaction. For example, the transaction data can include the purchase information associated with the payment transaction (e.g., a payment transaction value), the debit card holder identifier 142, information associated with the products and/or services purchased in the transaction. The product information may include stock-keeping unit (SKU).

As described above, the transaction capture module 250 can operate by routing the transaction data via a payment processing agent for the merchant, a deposit account-holding entity, and/or a debit card network to the mapping and switching module 230, and/or by routing the transaction data directly to the mapping and switching module 230.

Like the customer interface module 210, for the purpose of enhancing security, the transaction capture module 250 may transmit the debit card holder identifier 142 as a secure debit card holder token. The secure debit card holder token can be derived from information corresponding to the debit card held by the debit card holder. Although the secure debit card holder token is different from the debit card number of the debit card held by the debit card holder, as long as the correct unlocking security protocol is known, the secure debit card holder token can be decrypted to reveal the debit card information related to the debit card held by the debit card holder. In some embodiments, the debit card holder identifier 142 may correspond with the debit card number. In some other embodiments, the debit card holder identifier 142 may correspond with the secure debit card holder token.

On receipt of the transaction data, the mapping and switching module 230 may operate to process the transaction data.

When the mapping and switching module 230 processes the transaction data received from the merchant device 130, the mapping and switching module 230 can retrieve from the transaction data the debit card holder information, a merchant identifier, and the purchase information. The debit card holder information provided from the merchant device 130 may include the debit card holder identifier 142. In some embodiments, the mapping and switching module 230 may process the transaction data in real-time (e.g., continuously) or in one or more batches.

The mapping and switching module 230 can identify the loyalty program operator 150 based on the merchant identifier. The mapping and switching module 230 may then configure the purchase information into the preferred format for that loyalty program operator 150 before transmitting the purchase information to the loyalty program operator 150. This can be particularly helpful to program operators 150 since they do not need to further process the purchase information and thus can save on resources and costs. For example, a date can be presented in one format in the purchase information received from the merchant device 130 but preferred in a different format by a loyalty program operator 150. A date, such as Nov. 30, 2012, can be presented in the format “2012/11/30” in the purchase information from the merchant, but a loyalty program operator 150 may prefer the date to be presented in the format “11/30/2012”.

After processing the transaction data, the mapping and switching module 230 can query the debit card loyalty database 240 for an entry containing a debit card customer identifier corresponding to the debit card holder identifier 142 received from the merchant device 130.

If the mapping and switching module 230 locates an entry in the debit card loyalty database 240 containing a debit card customer identifier that corresponds to the debit card holder identifier 142, the mapping and switching module 230 can further query the located entry for a loyalty program account identifier for the loyalty program identifier corresponding to the merchant identifier received from the merchant device 130.

If the mapping and switching module 230 locates a loyalty program account identifier for the loyalty program from among the loyalty program account identifiers stored in the above located entry, the mapping and switching module 230 can provide the purchase information configured in the preferred format to the loyalty program operator 150 corresponding to that loyalty program. The configured purchase information can include the corresponding loyalty program account identifier. As described above, the loyalty program operator 150 can then determine the points and/or rewards based on the purchase information.

However, if there is no entry in the debit card loyalty database 240 that corresponds to the debit card holder identifier 142 or if an entry in the debit card loyalty database 240 corresponding to the debit card holder identifier 142 is not associated with a loyalty program account identifier for the merchant's loyalty program, the mapping and switching module 230 may coordinate with the customer interface module 210 to notify or indicate to that debit card holder of the existence and/or benefits of the merchant's loyalty program. For example, the mapping and switching module 230 can request for the customer interface module 210 to display or send a message regarding the merchant's loyalty program to that debit card holder (say by email or text message, for example). In some embodiments, the mapping and switching module 230 may nevertheless store the configured purchase information in a database accessible by the customer interface module 210 so that rewards may be retroactively collected if the debit card account identified by the debit card holder identifier 142 later becomes associated with the loyalty program offered by that merchant.

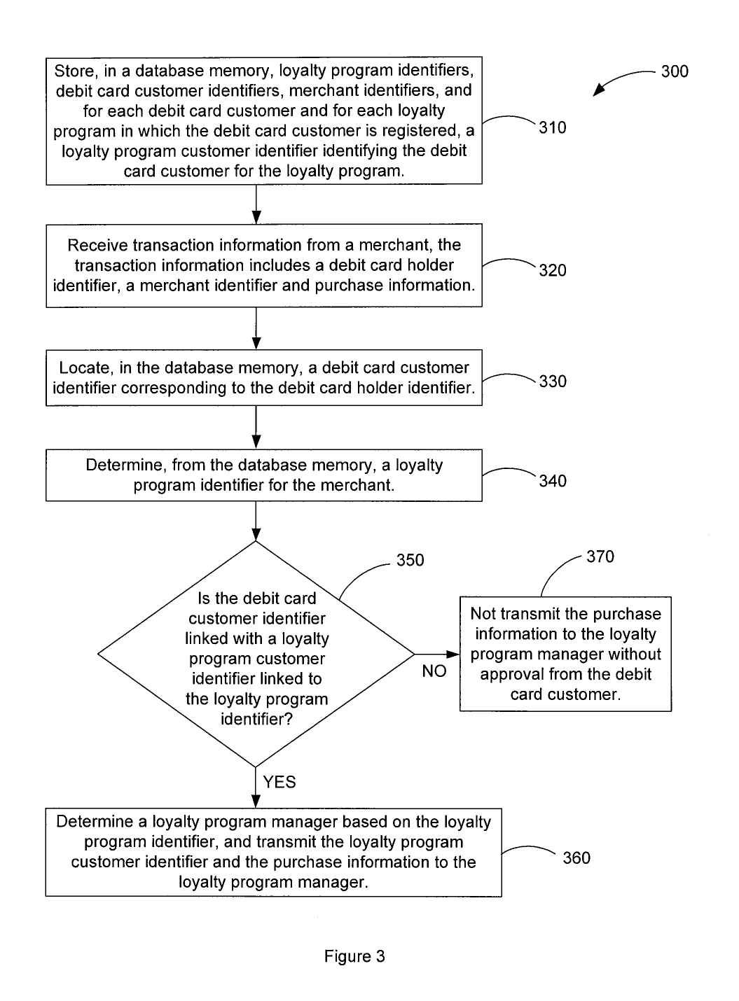

Referring now to FIG. 3, steps for providing loyalty programs via a debit card are shown in a flowchart diagram.

At step 310, store, in a database memory 240, loyalty program identifiers, debit card customer identifiers, merchant identifiers, and for each debit card customer and for each loyalty program in which the debit card customer is registered, a loyalty program customer identifier identifying the debit card customer for the loyalty program.

The loyalty program identifiers stored in the database memory 240 identify the loyalty programs registered in the debit card loyalty system 110. Each loyalty program identifier uniquely identifies a corresponding loyalty program. The debit card customer identifiers stored in the database memory 240 identify the debit card customers registered in, or whose information is accessible by, the debit card loyalty system 110. Each debit card customer identifier uniquely identifies a corresponding debit card customer. The merchant identifiers stored in the database memory 240 identify the merchants associated with any of the registered loyalty programs.

In the database memory 240, each loyalty program identifier is stored in linked relation to at least one merchant identifier, each debit card customer identifier is stored in linked relation to at least one loyalty program customer identifier, and each loyalty program customer identifier is stored in linked relation to an associated loyalty program identifier.

At step 320, receive transaction information from a merchant, where the transaction information includes debit card information, a merchant identifier and purchase information, and the debit card information can include a debit card holder identifier 142. This step can occur at the transaction capture module 250.

The debit card holder information can be derived from a debit card 140 held by a debit card holder, a merchant identifier identifying the merchant and purchase information regarding a purchase from the merchant by the debit card holder.

Steps 330 to 360 can be conducted at the mapping and switching processor 230. As described above, the mapping and switching processor 230 can be linked to the transaction capture module 250 and to the database memory 240 for communication therewith.

At step 330, determine, from the database memory 240, a loyalty program identifier for the merchant.

The loyalty program identifier can be determined by locating the merchant identifier in the database memory 240 and identifying the loyalty program identifier stored in linked relation with the located merchant identifier.

At step 340, determine if there is an entry in the database memory 240 with a debit card customer identifier that corresponds to the debit card holder identifier 142.

If it is determined at step 340 that there is an entry in the database memory 240 with a debit card customer identifier that corresponds to the debit card holder identifier 142, the mapping and switching processor 230 proceeds to perform step 350.

However, if it is determined at step 340 that there is no entry in the database memory 240 with a debit card customer identifier that corresponds to the debit card holder identifier 142, the mapping and switching processor 230 can proceed to perform step 370, which is to inform the debit card holder of the merchant's loyalty program and to store the purchase information in a database accessible by the debit card loyalty system 110 for that debit card holder.

Continuing from step 340, at step 350, determine if the debit card customer identifier is linked with a loyalty program customer identifier linked to the loyalty program identifier.

If it is determined at step 350 that the debit card customer identifier is linked with a loyalty program customer identifier linked to the loyalty program identifier, the mapping and switching processor 230 proceeds to perform step 360, which is to determine a loyalty program manager 150 based on the loyalty program identifier, and to transmit the loyalty program customer identifier and the purchase information to the loyalty program manager 150.

However, if it is determined at step 350 that the debit card customer identifier is not linked with a loyalty program customer identifier linked to the loyalty program identifier, the mapping and switching processor 230 proceeds to perform step 380, which is to not transmit the purchase information to the loyalty program manager 150 without approval from the debit card customer. For example, the purchase information may be stored until approval is received from the debit card customer to join the loyalty program, or, in some embodiments, may simply be discarded without being recorded.

Referring now to FIG. 4, a screenshot of an example online banking user interface 400 configured with the customer interface module 210 is shown.

As described above, existing online banking interfaces may be configured to include and implement the customer interface module 210. Generally, the online banking user interface 400 can be accessed from the user computing device 120 through an internet browser 410. A debit card user can login to the online banking user interface 400 using the debit card account identifier 142 and a corresponding password or pass key.

The online banking user interface 400 can provide various banking services. As illustrated in FIG. 4, the online banking user interface 400 can include various controls that may receive input from the debit card user for indicating a banking service they would like to conduct. The controls may be any user input control fields, such as a button and/or a Universal Resource Link (URL). For example, a control 430 that can receive input for redirecting the debit card user to an interface displaying a balance corresponding to one or more bank account(s), a control 432 that can receive input for redirecting the debit card user to an interface for transferring funds, a control 434 that can receive input for enrolling the debit card user into a loyalty program (referred to herein as a loyalty program enrollment control), a control 436 that can receive input for redirecting the debit card account to an interface for linking, or associating, one or more loyalty program accounts to the debit card account (referred to herein as a loyalty link control) and a control 438 for receiving input for redirecting the debit card customer to an interface for accessing linked, or associated, loyalty program accounts (referred to herein as a linked loyalty account control). In this example embodiment, a communication connection with the customer interface module 210 may be activated or initialized when the loyalty program enrollment control 434, the loyalty link control 436 and/or the linked loyalty account control 438 receives an input from the debit card customer.

When a debit card holder links a loyalty account to the debit card, that debit card holder becomes a debit card customer of the debit card loyalty system 110. The debit card holder can then be assigned or provided a corresponding debit card customer identifier. Optionally, before becoming a debit card customer, the debit card holder can be redirected to an interface, such as a membership interface, for receiving registration information before being registered into the debit card loyalty system 110, and being provided a corresponding debit card customer identifier.

As well, from the online banking user interface 400, the debit card holder can be redirected to an interface for registering and/or enrolling into loyalty programs after the loyalty program enrollment control 434 receives an input. As described above, the customer interface module 210 can operate to create a loyalty program account for the new loyalty program member, or alternatively, can forward the registration request to the loyalty program operator 150.

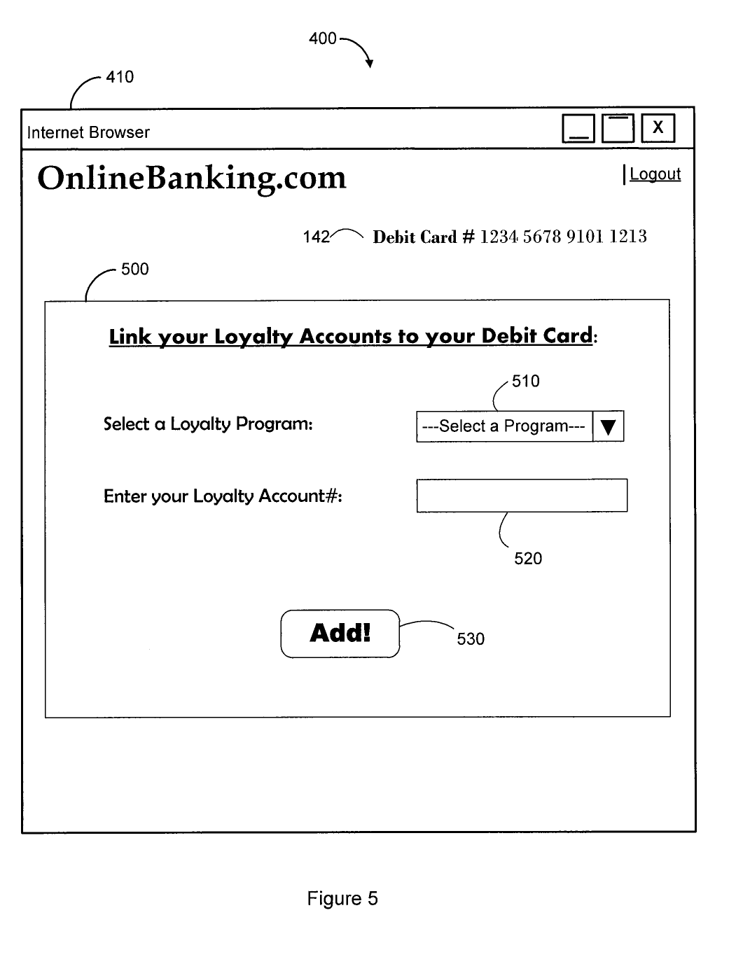

Referring to FIG. 5, and continuing with the above example, a screenshot of an interface 500 for linking a loyalty program account to the debit card account (referred to herein as the loyalty program interface) is shown. The loyalty program interface 500 is an example interface for accessing the customer interface module 210 from the user computing device 120. In this example embodiment, the loyalty program interface 500 can be accessed through the online banking user interface 400 after the loyalty link control 436 (FIG. 4) receives input from the debit card customer.

As illustrated in FIG. 5, the loyalty program interface 500 may be configured by the customer interface module 210 to include one or more controls for receiving information corresponding to a loyalty program account to be associated with the debit card account. For example, a drop down list control 510 for receiving an input selecting a loyalty program (referred to herein as a loyalty program selection control) and a field 520 for receiving input of a loyalty program account identifier (referred to herein as a loyalty account input field) may be provided on the loyalty program interface 500. A control button 530 for receiving input confirming and submitting the values in the loyalty program selection control 510 and the loyalty account input field 520 may also be provided.

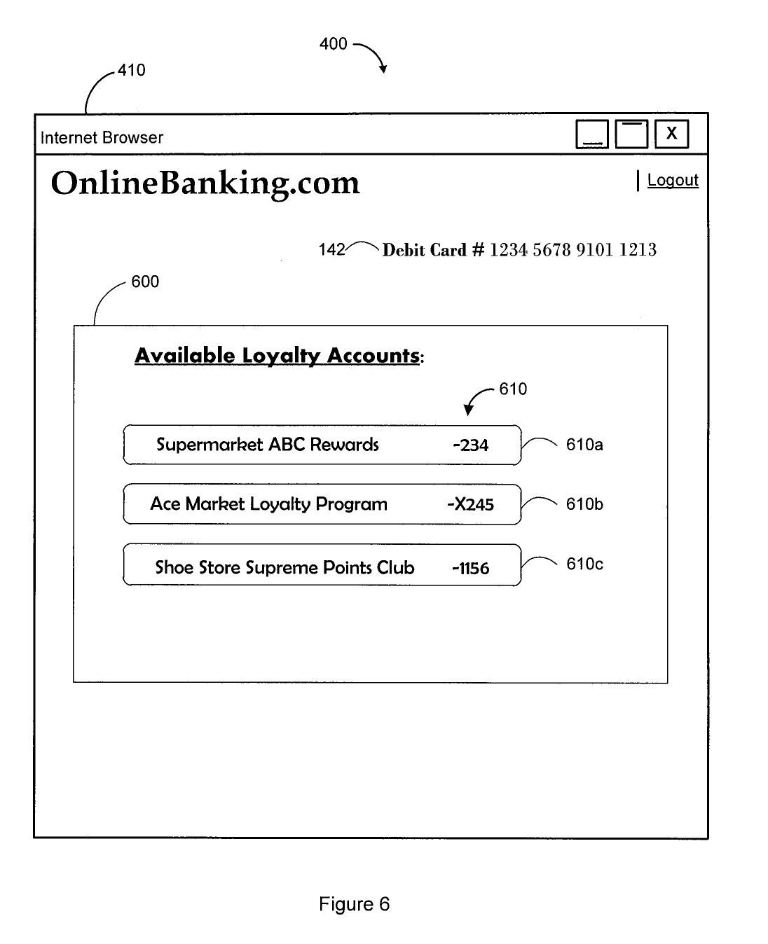

As described above, the customer interface module 210 may further provide an interface for accessing loyalty program accounts linked to the debit card account. Continuing with the above example and with reference to FIG. 6, a screenshot of an interface 600 for accessing loyalty program accounts linked to the debit card account (referred to herein as a linked programs interface). In this example embodiment, the linked programs interface 600 can be accessed through the online banking user interface 400 after the linked loyalty account control 438 (FIG. 4) receives input from the debit card customer.

As illustrated in FIG. 6, a list 610 of linked loyalty program accounts (referred to herein as loyalty account list) may be displayed on the linked programs interface 600. Each loyalty program account 610a, 610b and 610c can be provided on the linked programs interface 600 as a control for receiving input to redirect the debit card customer to further options related to each loyalty program account. The further options related to the loyalty program accounts may include an option to modify settings and preferences associated with the loyalty program account, and an option to display the account balance, for example.

Each of the identifiers described above are uniquely associated with the corresponding entity or information being identified. For example, with reference to FIG. 6, the loyalty program account 610a is associated with a loyalty program identifier corresponding to the Supermarket ABC Rewards loyalty program and a loyalty program account identifier “234”, the loyalty program account 610b is associated with a loyalty program identifier corresponding to the Ace Market Loyalty Program loyalty program and a loyalty program account identifier “X245”, and the loyalty program account 610c is associated with a loyalty program identifier corresponding to the Shoe Store Supreme Points Club loyalty program and a loyalty program account identifier “1156”. Similarly, each merchant has a unique merchant identifier, each debit card customer has a unique debit card customer identifier and each debit card holder has a unique debit card holder identifier.

The present invention has been described here by way of example only. Various modification and variations may be made to these exemplary embodiments without departing from the spirit and scope of the invention, which is limited only by the appended claims. For example, in the various user interfaces illustrated in the figures, it will be understood that the illustrated user interface text, fields and controls are provided as examples only and are not meant to be limiting. Other suitable user interface elements may be possible.

1. A method of linking a plurality of loyalty programs for a plurality of merchants and a plurality of debit card customers, the method comprising:
a) storing, in a database memory,
i) a plurality of loyalty program identifiers identifying the plurality of loyalty programs, wherein each loyalty program identifier uniquely identifies a loyalty program in the plurality of loyalty programs;
ii) a plurality of debit card customer identifiers identifying the plurality of debit card customers, wherein each debit card customer identifier uniquely identifies a debit card customer in the plurality of debit card customers;
iii) for each debit card customer and for each loyalty program in which that debit card customer is registered, a loyalty program customer identifier identifying that debit card customer for that loyalty program; and
iv) a plurality of merchant identifiers identifying the plurality of merchants;
wherein,
each loyalty program identifier in the plurality of loyalty program identifiers is stored in the database memory in linked relation to at least one merchant identifier in the plurality of merchant identifiers,
each debit card customer identifier in the plurality of debit card customer identifiers is stored in the database memory in linked relation to at least one loyalty program customer identifier in the plurality of loyalty program customer identifiers, and
each loyalty program customer identifier is stored in the database memory in linked relation to an associated loyalty program identifier;
b) at a transaction capture module, receiving transaction information from a merchant in the plurality of merchants,
wherein the transaction information comprises debit card holder information derived from a debit card held by a debit card holder, a merchant identifier identifying the merchant and purchase information regarding a purchase from the merchant by the debit card holder, and
wherein the debit card holder information comprises a debit card holder identifier; and
c) operating a mapping and switching processor, linked to the transaction capture module and to the database memory for electronic communication therewith, to
i) locate, in the database memory, a debit card customer identifier corresponding to the debit card holder identifier;
ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier; and
iii) determine if the debit card customer identifier is stored in the database memory in linked relation with a loyalty program customer identifier that is stored in the database memory in linked relation to the loyalty program identifier for the merchant and,
if so, determining a loyalty program manager based on the determined loyalty program identifier, and transmitting the loyalty program customer identifier and the purchase information to the loyalty program manager;
otherwise, not transmitting the purchase information to the loyalty program manager without approval from the debit card customer corresponding to the debit card customer identifier.

2. The method as defined in claim 1, wherein
the debit card is useable at each merchant in the plurality of merchants to withdraw funds from a deposit account held by the debit card customer at a deposit account-holding entity to effect the purchase using an electronic connection connecting the merchant to the deposit account-holding entity,
the transaction capture module is electronically linked to the electronic connection connecting the merchant to the deposit account-holding entity, and
the step of receiving transaction information from the merchant comprises taking the debit card holder information, the merchant identifier, and the purchase information from the electronic connection connecting the merchant to the deposit account-holding entity.

3. The method as defined in claim 2, wherein
the transaction information is received from the merchant via at least one of the deposit account-holding entity, a debit card network, and a processing agent for the merchant that processes payments on behalf of the merchant.

4. The method as defined in claim 1, further comprising,
for each debit card customer in the plurality of debit card customers, providing access for that debit card customer to a customer interface module comprising a loyalty program interface operable by that debit card customer to view information regarding one or more loyalty programs in the plurality of loyalty programs,
the loyalty program interface being further operable by that debit card customer to select a loyalty program having a loyalty program identifier, to provide a loyalty program customer identifier for identifying the debit card customer for that loyalty program, to store that loyalty program customer identifier in the database memory in linked relation to the loyalty program identifier for that loyalty program and to update the database memory to store that loyalty program customer identifier in linked relation to that debit card customer identifier.

5. The method as defined in claim 4, further comprising,
for a debit card holder not in the plurality of debit card customers, providing access for that debit card holder to the customer interface module, the customer interface module further comprising a membership interface operable to register the debit card holder as a new debit card customer in the plurality of debit card customers by adding a new debit card customer identifier to the plurality of debit card customer identifiers,
the loyalty program interface being further operable by that new debit card customer to view information regarding one or more loyalty programs in the plurality of loyalty programs,
the loyalty program interface being further operable by that new debit card customer to select a loyalty program having a loyalty program identifier, to provide a loyalty program customer identifier for identifying the new debit card customer for that loyalty program, to store that loyalty program customer identifier in the database memory in linked relation to that loyalty program identifier and to update the database memory to store that loyalty program customer identifier in linked relation to that new debit card customer identifier.

6. The method as defined in claim 5, wherein
the customer interface module is accessible via at least one of an online banking website and a mobile banking interface accessible to the debit card holder and the debit card customer.

7. The method as defined in claim 4, wherein prior to selecting the loyalty program, that debit card customer is not a member of the selected loyalty program.

8. The method as defined in claim 1, further comprising,
for each debit card customer in the plurality of debit card customers, providing access for that debit card customer to a customer interface module comprising a loyalty program interface operable by that debit card customer i) to view information regarding one or more loyalty programs in the plurality of loyalty programs, and ii) to select a loyalty program having a loyalty program identifier, wherein the debit card customer is an existing member of the loyalty program and the debit card customer identifier for that debit card customer is not stored in the database memory in linked relation to a loyalty program customer identifier for that loyalty program;
the loyalty program interface being further operable by that debit card customer to provide a loyalty program customer identifier for identifying the debit card customer for that loyalty program, to store that loyalty program customer identifier in the database memory in linked relation to the loyalty program identifier for that loyalty program and to update the database memory to store that loyalty program customer identifier in linked relation to that debit card customer identifier.

9. The method as defined in claim 1, wherein,
after determining the loyalty program identifier for the merchant based on the merchant identifier and determining that the debit card customer identifier is not registered in the loyalty program identified by the determined loyalty program identifier,
preparing a message to the debit card customer corresponding to the debit card customer identifier asking if that debit card customer wants to be signed up to that loyalty program.

10. The method as defined in claim 9, further comprising,
storing, in the database memory, the purchase information in linked relation to the debit card customer identifier;
then,
receiving a request from that debit card customer to register in that loyalty program;
providing a new loyalty program customer identifier for that loyalty program for that debit card customer;
storing the new loyalty program customer identifier in the database memory in linked relation to both the debit card customer identifier and the loyalty program identifier; and
operating the mapping and switching processor to:
retrieve the stored transaction information for that debit card customer,
determine a loyalty program manager based on the determined loyalty program identifier, and
transmit the new loyalty program customer identifier and the purchase information to the loyalty program manager.

11. The method as defined in claim 1, wherein
the debit card holder identifier is a secure debit card holder token derived from the debit card holder information and is different from a debit card number of the debit card held by the debit card holder; and
each debit card customer identifier stored in the database memory corresponds to a secure debit card customer token, the secure debit card customer token is derived from debit card information corresponding to a debit card held by the debit card customer and is different from a debit card number of the debit card held by the debit card customer.

12. The method as defined in claim 11, wherein the secure debit card holder token is the secure debit card customer token when the debit card held by the debit card holder is the debit card held by the debit card customer.

13. The method as defined in claim 1, wherein,
after determining the loyalty program manager based on the determined loyalty program identifier, transmitting a request to redeem a reward to the loyalty program manager.

14. The method as defined in claim 1, further comprising
storing, in the database memory a plurality of purchase information formats comprising, for each loyalty program, a purchase information format identifying a format to which the purchase information is to be configured before being transmitted to the loyalty program manager, wherein each purchase information format is stored in the database memory in linked relation to a loyalty program identifier for the corresponding loyalty program and at least two of the purchase information formats in the plurality of purchase information formats are different;
before transmitting the purchase information to the loyalty program manager, determining the purchase information format based on the loyalty program identifier and configuring the purchase information based on the determined purchase information format; and
transmitting the loyalty program customer identifier and the configured purchase information to the loyalty program manager.

15. A system for linking a plurality of loyalty programs for a plurality of merchants and a plurality of debit card customers, the system comprising:
a database memory, for storing
i) a plurality of loyalty program identifiers identifying the plurality of loyalty programs, wherein each loyalty program identifier uniquely identifies a loyalty program in the plurality of loyalty programs;
ii) a plurality of debit card customer identifiers identifying the plurality of debit card customers, wherein each debit card customer identifier uniquely identifies a debit card customer in the plurality of debit card customers;
iii) for each debit card customer and for each loyalty program in which that debit card customer is registered, a loyalty program customer identifier identifying that debit card customer for that loyalty program; and
iv) a plurality of merchant identifiers identifying the plurality of merchants;
wherein,
each loyalty program identifier in the plurality of loyalty program identifiers is stored in the database memory in linked relation to at least one merchant identifier in the plurality of merchant identifiers,
each debit card customer identifier in the plurality of debit card customer identifiers is stored in the database memory in linked relation to at least one loyalty program customer identifier in the plurality of loyalty program customer identifiers, and
each loyalty program customer identifier is stored in the database memory in linked relation to an associated loyalty program identifier;
a transaction capture module configured to receive transaction information from a merchant in the plurality of merchants,
wherein the transaction information comprises debit card holder information derived from a debit card held by a debit card holder, a merchant identifier identifying the merchant and purchase information regarding a purchase
from the merchant by the debit card holder, and
wherein the debit card holder information comprises a debit card holder identifier;
a mapping and switching processor, linked to the transaction capture module and to the database memory for electronic communication therewith, the mapping and switching processor being configured to
i) locate, in the database memory, a debit card customer identifier corresponding to the debit card holder identifier;
ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier; and
iii) determine if the debit card customer identifier is stored in the database memory in linked relation with a loyalty program customer identifier that is stored in the database memory in linked relation to the loyalty program identifier for the merchant and, if so, determine a loyalty program manager based on the determined loyalty program identifier, and transmitting the loyalty program customer identifier and the purchase information to the loyalty program manager.

16. The system as defined in claim 15, wherein
the debit card is useable at each merchant in the plurality of merchants to withdraw funds from a deposit account held by the debit card customer at a deposit account-holding entity to effect the purchase using an electronic connection connecting the merchant to the deposit account-holding entity,
the transaction capture module is electronically linked to the electronic connection connecting the merchant to the deposit account-holding entity, and is configured to receive the transaction information from the merchant by taking the debit card holder information, the merchant identifier, and the purchase information from the electronic connection connecting the merchant to the deposit account-holding entity.

17. The system as defined in claim 16, wherein the transaction information is received from the merchant via at least one of the deposit account-holding entity, a debit card network, and a processing agent for the merchant that processes payments on behalf of the merchant.

18. The system as defined in claim 15, further comprising a customer interface module configured to provide a loyalty program interface operable by a debit card customer to view information regarding one or more loyalty programs in the plurality of loyalty programs, the loyalty program interface being further operable by that debit card customer to select a loyalty program having a loyalty program identifier, to provide a loyalty program customer identifier for identifying the debit card customer for that loyalty program, to store that loyalty program customer identifier in the database memory in linked relation to the loyalty program identifier for that loyalty program and to update the database memory to store that loyalty program customer identifier in linked relation to that debit card customer identifier.

19. The system as defined in claim 18 wherein
the customer interface module is accessible by a debit card holder not in the plurality of debit card customers, and further comprise a membership interface operable to register the debit card holder as a new debit card customer in the plurality of debit card customers by adding a new debit card customer identifier to the plurality of debit card customer identifiers; and
the loyalty program interface is further operable by that new debit card customer to i) view information regarding one or more loyalty programs in the plurality of loyalty programs, ii) select a loyalty program having a loyalty program identifier, iii) provide a loyalty program customer identifier for identifying the new debit card customer for that loyalty program, iv) store that loyalty program customer identifier in the database memory in linked relation to that loyalty program identifier, and v) update the database memory to store that loyalty program customer identifier in linked relation to that new debit card customer identifier.

20. The system as defined in claim 19, wherein
the customer interface module is accessible via at least one of an online banking website and a mobile banking interface accessible to the debit card holder and the debit card customer.

21. The system as defined in claim 18, wherein prior to selecting the loyalty program, that debit card customer is not a member of the selected loyalty program.

22. The system as defined in claim 15, further comprising, a customer interface module comprising a loyalty program interface configured to be operable by that debit card customer i) to view information regarding one or more loyalty programs in the plurality of loyalty programs, and ii) to select a loyalty program having a loyalty program identifier, wherein the debit card customer is an existing member of the loyalty program and the debit card customer identifier for that debit card customer is not stored in the database memory in linked relation to a loyalty program customer identifier that loyalty program;
the loyalty program interface being further operable by that debit card customer
to provide a loyalty program customer identifier for identifying the debit card customer for that loyalty program, to store that loyalty program customer identifier in the database memory in linked relation to the loyalty program identifier for that loyalty program and to update the database memory to store that loyalty program customer identifier in linked relation to that debit card customer identifier.

23. The system as defined in claim 15, wherein, when the mapping and switching processor determines the loyalty program identifier for the merchant based on the merchant identifier and determines that the debit card customer identifier is not registered in the loyalty program identified by the determined loyalty program identifier, the customer interface module is configured to prepare a message to the debit card customer corresponding to the debit card customer identifier asking if that debit card customer wants to be signed up to that loyalty program.

24. The system as defined in claim 23, wherein
when the mapping and switching processor determines the loyalty program identifier for the merchant based on the merchant identifier and determines that the debit card customer identifier is not registered in the loyalty program identified by the determined loyalty program identifier, the database memory is further operable to store the purchase information in linked relation to that debit card customer identifier; and
when the customer interface module receives a request from that debit card customer to register in that loyalty program, the customer interface module is configured to provide a new loyalty program customer identifier for that loyalty program for that debit card customer, the database memory is configured to store the new loyalty program customer identifier in linked relation to both the debit card customer identifier and the loyalty program identifier, and the mapping and switching processor is configured to:
retrieve the stored transaction information for that debit card customer,
determine a loyalty program manager based on the determined loyalty program identifier, and
transmit the new loyalty program customer identifier and the purchase information to the loyalty program manager.

25. The system as defined in claim 15, wherein
the debit card holder identifier is a secure debit card holder token derived from the debit card holder information and is different from a debit card number of the debit card held by the debit card holder; and
each debit card customer identifier stored in the database memory corresponds to a secure debit card customer token, the secure debit card customer token is derived from debit card information corresponding to a debit card held by the debit card customer and is different from a debit card number of the debit card held by the debit card customer.

26. The system as defined in claim 25, wherein the secure debit card holder token is the secure debit card customer token when the debit card held by the debit card holder is the debit card held by the debit card customer.
